(19) United States
(12) Patent Application Publication
(10) Pub. No.: US 2024/0112471 A1
(43) Pub. Date: Apr. 4, 2024

(54) System and Method for Trailer and Trailer Coupler Recognition via Classification

(71) Applicant: Continental Automotive Systems, Inc., Auburn Hills, MI (US)

(72) Inventors: Eduardo Jose Ramirez Llanos, Rochester, MI (US); Julien Ip, Royal Oak, MI (US)

(73) Assignee: Continental Automotive Systems, Inc., Auburn Hills, MI (US)

(21) Appl. No.: 17/936,933

(22) Filed: Sep. 30, 2022

(51) Int. Cl. G06V 20/56; B60R 1/00; G06V 10/762

(52) U.S. Cl. CPC G06V 20/56; B60R 1/003; G06V 10/762; B60R 2300/808

(57) ABSTRACT

A method and system are disclosed for identifying a trailer or trailer coupler in an image. The method includes obtaining a database of descriptor clusters. Each descriptor cluster has at least one label assigned thereto. Each at least one label is a label for a trailer or trailer coupler, or for a background. Image data pertaining to an image is received. Features and descriptors are determined in the received image data. For each determined descriptor, the method includes matching the determined descriptor with a descriptor cluster in the database and assigning the label corresponding to the matched descriptor cluster to the determined descriptor. Based upon the determined descriptors having the assigned label corresponding to one of a trailer or a trailer coupler, the method includes determining a convex hull of a representation of the one of the trailer or trailer coupler in the image.

### TECHNICAL FIELD

This disclosure relates to recognizing trailer and/or trailer coupler representations in image data, and particularly to a system and method for recognizing trailer and trailer coupler representations using texture classification.

### BACKGROUND

It is known in computer vision systems for vehicles to detect a trailer in images captured by a rear camera of a tow vehicle. Such systems often include graphic processing units (GPUs) or high-end central processing units (CPUs). However, GPUs and high-end CPUs can be relatively expensive.

### SUMMARY

Example embodiments are directed to a method for identifying a trailer or trailer coupler in one or more images. The method includes obtaining a database of descriptor clusters. Each descriptor cluster has at least one label assigned thereto. Each at least one label is a label for a trailer o trailer coupler, or for a background. The method further includes receiving, at data processing hardware, image data pertaining to one or more images. The method includes determining, by data processing hardware, features and descriptors in the received image data. For each determined descriptor, the method includes matching, by the data processing hardware, the determined descriptor with a descriptor cluster in the database and assigning the label corresponding to the matched descriptor cluster to the determined descriptor. Based upon the determined descriptors having the assigned label corresponding to at least one of a trailer or a trailer coupler, the method further includes determining, by the data processing hardware, a convex hull of a representation of the at least one of the trailer or the trailer coupler in the one or more images.

The method may further include generating the database of descriptor clusters, including receiving training image data and generating labels and descriptors for the training image data. The method further includes clustering the descriptors and generating the database of descriptor clusters from the clustered descriptors.

The method may further include adding weights to each descriptor cluster, wherein generating the database of descriptor clusters is based at least partly upon the weights added to the descriptor clusters.

In an aspect, adding weights to each descriptor cluster uses a term frequency-inverse document frequency algorithm.

Clustering the descriptors may include unsupervised learning and/or using a k-means clustering algorithm.

Clustering the descriptors may include using a support vector machine (SVM) learning algorithm.

The method may further include performing a pyramid of scales algorithm on the received image data to produce scale invariant image data, wherein determining features and descriptors includes determining features and descriptors of the scale invariant image data.

Determining descriptors of the received image data may include performing one of a number of algorithms, such as Scale Invariant Feature Transform (SIFT), Speeded Up Robust Features (SURF), Binary Robust Independent Elementary Features (BRIEF), rBRIEF, Histogram of Oriented Gradients (HOG), or a neural network visual descriptor algorithm.

Determining features of the received image data may include performing one of a FAST, Harris Corners, or a boundary based corner detection algorithm.

An example embodiment is directed to a system for identifying a trailer or trailer coupler in one or more images. The system includes a controller including data processing hardware and non-transitory memory communicatively coupled to the data processing hardware and having instructions stored therein which, when executed by the data processing hardware, causes the data processing hardware to perform the method described above.

Another example embodiment is directed to a method for identifying a trailer or trailer coupler in one or more images, including receiving training image data and generating labels and descriptors for the training image data. The descriptors are clustered. The method further includes generating a database of descriptor clusters from the clustered descriptors. Each descriptor cluster has at least one label assigned thereto. Each at least one label being a label for at least a portion of a trailer or a background. The method further includes receiving, at data processing hardware, image data pertaining to one or more images; and based upon the received image data and the database, determining a convex hull of a representation of the at least a portion of the trailer in the one or more images.

The method may further include adding weights to each descriptor cluster, wherein generating the database of descriptor clusters is based at least partly upon the weights added to the descriptor clusters. Adding weights to each descriptor cluster uses a term frequency-inverse document frequency algorithm.

### DESCRIPTION OF DRAWINGS

FIG. 1 is a top view of a tow vehicle and a trailer.

FIG. 2 is a block diagram schematic of the tow vehicle according to an example embodiment.

FIG. 3 is a display of a trailer captured by a rear camera of the tow vehicle; and

FIGS. 4 and 5 are flowcharts for generating a dictionary or database of clustered descriptors and deploying the dictionary or database during a trailer assist function, respectively.

Like reference symbols in the various drawings indicate like elements.

### DETAILED DESCRIPTION

Example embodiments of the present disclosure are directed to detecting and localizing the representation of a trailer and/or a trailer coupler in one or more images. The example embodiments do not utilize graphic processing units (GPUs) or high-end central processing units (CPUs) in recognizing the location of trailer/trailer coupler representations in images. Instead, a dictionary or database of trailers and/or trailer coupler descriptors is generated using training image data depicting trailers and/or trailer couplers, with each dictionary/database entry having a label identifying the corresponding the descriptor as corresponding to a trailer and/or a trailer coupler or to background. Once generated, the dictionary/database of trailers and/or trailer couplers serves as a lookup table such that by matching descriptors from a current image to descriptors in the dictionary/database, the label of the matched dictionary/database entry is assigned to the corresponding descriptor in the current image. The location of the trailer and/or trailer coupler in the current image may be represented using a convex hull or bounding box which surrounds the features and the corresponding descriptors having a label of a trailer and/or a trailer coupler. Accessing the dictionary/database of descriptors labeled as a trailer and/or trailer coupler to identify the trailer and/or trailer coupler representation in the image advantageously only requires a low-end processing architecture without GPUs or other high-end CPUs. Identification of the trailer and/or trailer coupler in captured images may be used in any of a number of trailer assist functions, such as trailer reverse assist and trailer hitch assist functions.

Though determining trailer and/or trailer coupler position in images, according to example embodiments of the present disclosure, may be used in conjunction with a number of different trailering driving assist functions, the example embodiments will be described below in connection with a trailer hitch driving assist function for reasons of simplicity.

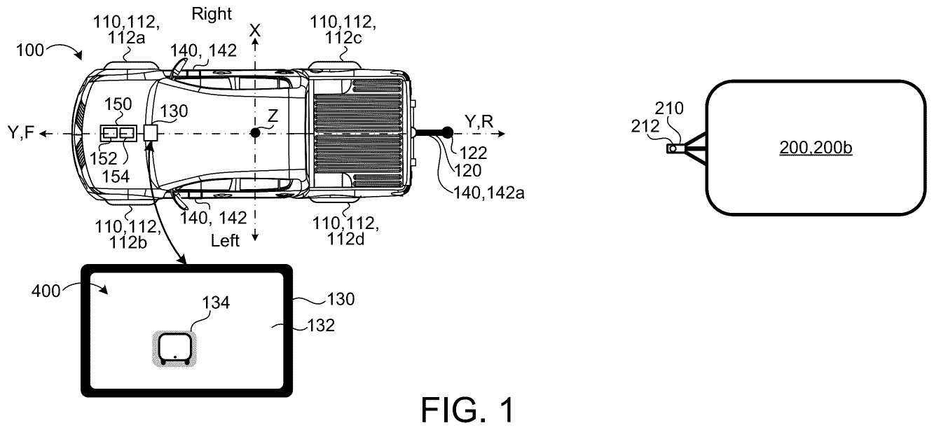

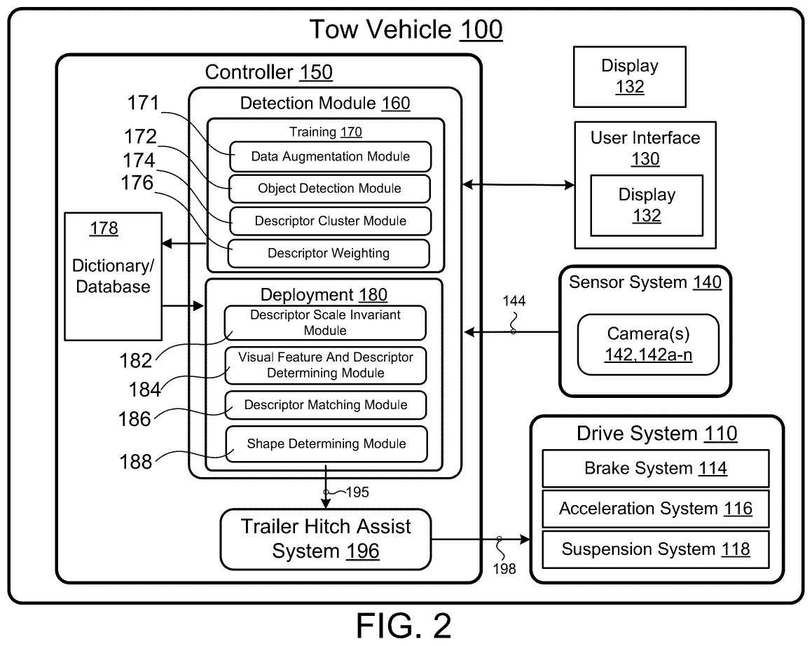

Referring to FIGS. 1 and 2, in some implementations, a driver of a tow vehicle 100 wants to tow a trailer 200 positioned behind the tow vehicle 100. The tow vehicle 100 may be configured to receive an indication of a driver's intent to drive towards a trailer 200 for coupling therewith. In some examples, the driver maneuvers the tow vehicle 100 towards the selected trailer 200; while in other examples, the tow vehicle 100 autonomously drives towards the selected trailer 200. The tow vehicle 100 may include a drive system 110 that maneuvers the tow vehicle 100 across a road surface based on drive commands having x, y, and z components, for example. As shown, the drive system 110 includes a front right wheel 112, 112a, a front left wheel 112, 112b, a rear right wheel 112, 112c, and a rear left wheel 112, 112d. The drive system 110 may include other wheel configurations as well. The drive system 110 may also include a brake system 114 that includes brakes associated with each wheel 112, 112a-d, and an acceleration system 116 that is configured to adjust a speed and direction of the tow vehicle 100. In addition, the drive system 110 may include a suspension system 118 that includes tires associates with each wheel 112, 112a-d, tire air, springs, shock absorbers, and linkages that connect the tow vehicle 100 to its wheels 112, 112a-d and allows relative motion between the tow vehicle 100 and the wheels 112, 112a-d. The suspension system 118 may be configured to adjust a height of the tow vehicle 100 allowing a tow vehicle hitch 120 (e.g., a tow vehicle hitch ball 122) to align with a trailer hitch 210 (e.g., coupler-tow-bar combination 210) supported by a trailer tow-bar 214, which allows for connection between the tow vehicle 100 and the trailer 200.

The tow vehicle 100 may move across the road surface by various combinations of movements relative to three mutually perpendicular axes defined by the tow vehicle 100: a transverse axis Xᵥ, a fore-aft axis Yᵥ, and a central vertical axis Zᵥ. The transverse axis x extends between a right side and a left side of the tow vehicle 100. A forward drive direction along the fore-aft axis Yᵥ is designated as Fᵥ, also referred to as a forward motion. In addition, an aft or reverse drive direction along the fore-aft direction Yᵥ is designated as Rᵥ, also referred to as rearward or reverse motion. When the suspension system 118 adjusts the suspension of the tow vehicle 100, the tow vehicle 100 may tilt about the Xᵥ axis and or Yᵥ axis, or move along the central vertical axis Zᵥ.

The tow vehicle 100 may include a user interface 130, such as, a display. The user interface 130 receives one or more user commands from the driver via one or more input mechanisms or a touch screen display 132 and/or displays one or more notifications to the driver. The user interface 130 is in communication with a vehicle controller 150, which in turn is in communication with a sensor system 140. In some examples, the user interface 130 displays an image of an environment of the tow vehicle 100 leading to one or more commands being received by the user interface 130 (from the driver) that initiate execution of one or more behaviors. In some examples, the user display 132 displays a representation 136 of the trailer 200 positioned behind the tow vehicle 100. In some examples, the controller 150 detects one or more trailers 200 and detects and localizes the center of the trailer 200 or trailer coupler 212 of the one or more trailers. The vehicle controller 150 includes a computing device (or processor) 152 (e.g., central processing unit having one or more computing processors) in communication with non-transitory memory 154 (e.g., a hard disk, flash memory, random-access memory, memory hardware) capable of storing instructions executable on the computing processor(s) 152.

The tow vehicle 100 may include a sensor system 140 to provide reliable and robust driving. The sensor system 140 may include different types of sensors that may be used separately or with one another to create a perception of the environment of the tow vehicle 100 that is used for the tow vehicle 100 to drive and aid the driver in make intelligent decisions based on objects and obstacles detected by the sensor system 140 or aids the drive system 110 in autonomously maneuvering the tow vehicle 100. The sensor system 140 may include, but is not limited to, radar, sonar, LIDAR (Light Detection and Ranging, which can entail optical remote sensing that measures properties of scattered light to find range and/or other information of a distant target), LADAR (Laser Detection and Ranging), ultrasonic sensor(s), etc.

In some implementations, the sensor system 140 includes one or more cameras 142 supported by the vehicle. In some examples, the sensor system 140 includes a rear-view camera 142a mounted to provide a view of a rear-driving path of the tow vehicle 100. The rear-view camera 142a may include a fisheye lens that includes an ultra wide-angle lens that produces strong visual distortion intended to create a wide panoramic or hemispherical image. Fisheye cameras 142a capture images having an extremely wide angle of view. Moreover, images captured by the fisheye camera 142a have a characteristic convex non-rectilinear appearance.

Referring to FIG. 2, the vehicle controller 150 includes a detection module or algorithm 160 that receives images 144 from the rear camera 142a (i.e., fisheye images) and determines the location of the trailer 200 and/or the location of the coupler 212 within the image(s) 144. In some implementations, the detection module 160 includes a training/learning phase 170 followed by a deployment phase 180. During the training/learning phase 170, the detection module 160 executes a number of trailer and coupler training modules 172-176 using training image data, resulting in a dictionary or database 178 being generated of visual features and descriptors with labeling indicating that the feature/descriptor corresponds to a trailer, a trailer coupler or background. In addition, during the deployment phase 180, the detection module 160 executes a number of modules 182-188 which use the dictionary/database 178 to provide, to each descriptor appearing in an image 144 recently captured by the rear camera 142a, the label corresponding to a matching descriptor from the dictionary 178. With descriptors in the recently captured image 144 and their corresponding labels from the matched descriptors in the dictionary 178, the detection module 160 is able to identify the location of the representation of the trailer 200 and/or the trailer coupler 212 in the recently captured image 144. Such identifications may be used by the trailer hitch assist system 196 or other trailering driving assist systems.

### Training/Learning Phase 170

With continued reference to FIG. 2, during the training phase the detection module 160 receives numerous training input images 144 captured by the rear camera 410 and/or other rear-mounted cameras facing trailers. For each training image 144 received, an object detection module or algorithm 172 determines a region(s) of interest (ROI) and marks pixels, such as pixels in the ROI in the training image 144, with labels such that pixels have labels corresponding to a trailer, a trailer coupler or background. In detecting ROIs and/or pixels as corresponding to a trailer, a trailer coupler or background, the object detection module 172 provides features, descriptors and labels to pixels in the training input images 144. In one example, the object detection module 172 is a trained deep neural network classifier that had been trained to receive input images and generate features, descriptors and labels for ROIs or pixels in the training input images 144. The result is a great number of feature descriptors with labels, with each descriptor having a label of a trailer, a trailer coupler or background.

A cluster module or algorithm 174 receives the numerous features with descriptors and labels, and clusters the descriptors. In one example, the cluster module 174 uses unsupervised learning and in particular a k-means algorithm. In another example, the cluster module 174 uses a SVM algorithm. The clustering module 174 serves to internally classify the descriptors to organize different types of textures (descriptors) for the trailer.

In either case, the cluster module 174 clusters the descriptors and forms a dictionary or database 178 of clustered descriptors with corresponding features and labels. Each entry in the dictionary 178 is given by each cluster. In other words, each entry in the dictionary 178 is a cluster (with corresponding feature(s) and label(s)). Provided the dataset or training image data is representative of many trailers, the dictionary/database is universal and can be used to identify many different trailers in image data.

Because some clustered descriptors may be more relevant and/or discriminative than other clustered descriptors to identify a trailer or trailer coupler, a descriptor weighting module or algorithm 176 is utilized. Every clustered descriptor in the dictionary 178 is ranked by the descriptor weighting module 176 based upon its determined relevance. Here a statistical measure may be used such as term frequency-inverse document frequency (TF-IDF) algorithm. The descriptor weighting module 176 updates the dictionary or database 178 for taking into consideration more common trailer descriptors. A fully trained dictionary 178 of weighted descriptor clusters is available for use to detect trailer and/or trailer coupler representations in images during the deployment phase 180, with each descriptor cluster having a label of a trailer, a trailer coupler or background.

### Deployment Phase 180

With continued reference to FIG. 2, during the deployment phase 180, the controller 150 receives captured images 144 from the rear camera 142a of the tow vehicle 100. A visual feature and descriptor determining module or algorithm 184 finds sparse visual features in the captured image. In an example, the algorithm 184 uses any one of a number of well known algorithms such as FAST, Harris Corners or a boundary based corner detection algorithm. The visual feature and descriptor determining module 184 also determines descriptors corresponding to the determined features. In one example, the visual feature and descriptor determining module 184 uses any one of a number of well known algorithms such as SIFT, SURF, BRIEF, rBRIEF, HOG or a neural network visual descriptor algorithm.

A descriptor matching module or algorithm 186 receives the features and corresponding descriptors from a received captured image 144 and, for each descriptor received, matches the descriptor with a descriptor cluster in the dictionary 178. Once a matched descriptor cluster is identified from the dictionary 178, the label (corresponding to a trailer, a trailer coupler or background) of the matched descriptor cluster is assigned to the descriptor. The output of the descriptor matching algorithm 186 is the captured image 144 having features and descriptors, with the features and corresponding descriptors having a label corresponding to a trailer, a trailer coupler or background from the matched descriptor cluster in the dictionary 178.

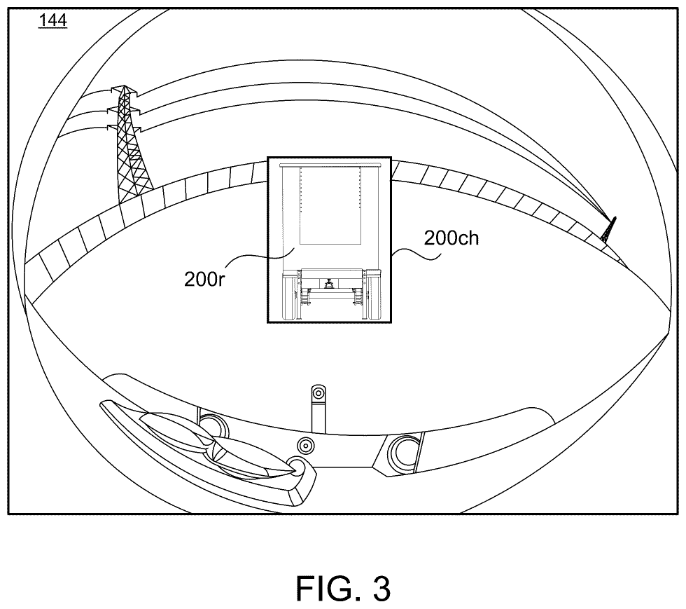

A shape determining module or algorithm 188 receives the recently captured image 144 provided at least partly by the descriptor matching algorithm 186 and determines a convex hull, shape, and/or bounding box surrounding the representation of the trailer 200 or trailer coupler 212 in the captured image 144. The shape determining module 188 creates the convex hull around all of the features and feature descriptors of the captured image 144 having a label corresponding to a trailer or trailer coupler. The convex hull information is then available for use by the vehicle controller 150 to, for example, display the convex hull on the display 132 of the user interface 130 along with the captured image 144. FIG. 3 illustrates an image 144 captured by the rear camera 142a having a representation 200r of a trailer 200, with the determining convex hull 200ch surrounding the trailer representation 200r. As illustrated, all features and feature descriptors having the “trailer” label are contained within the convex hull.

In addition, a convex hull may be provided which surrounds descriptors having the label of a trailer coupler.

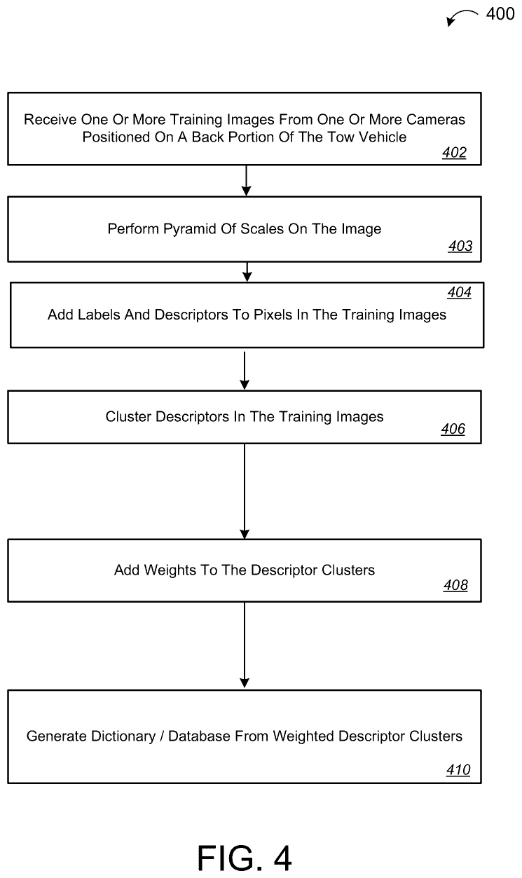

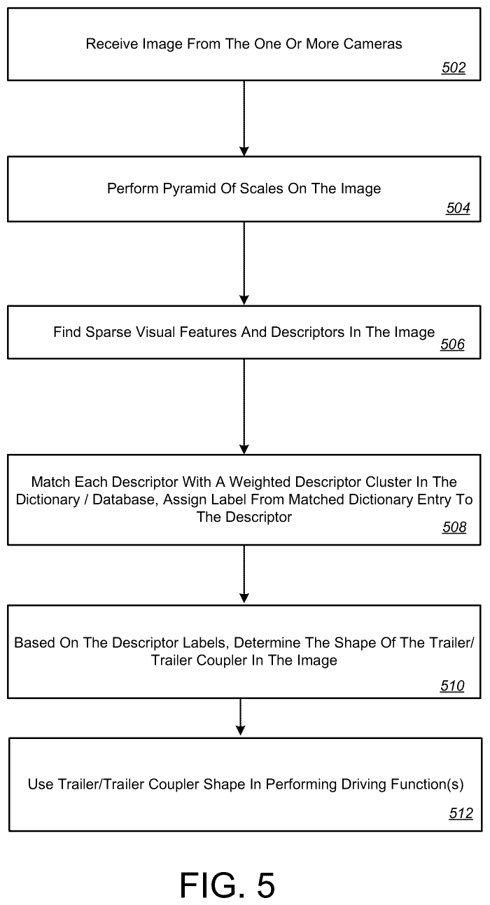

A method of detecting and localizing a trailer or trailer coupler representation in a captured image will be described with respect to FIGS. 4 and 5. In the training phase 170, training image data 144 is received at 402 at the controller 150. A data augmentation operation is optionally performed on the received training image data 144 at 403 by a data augmentation module or algorithm, such as descriptor scale invariant module 171. The object detection module 172 creates features and descriptors at 404 for the image 144 together with a corresponding label which classifies the corresponding feature and feature descriptor as a trailer, trailer coupler or background. In performing this classification, the object detection module 172 generates numerous labeled features and feature descriptors. The cluster module 174 clusters the descriptors at 406 and forms the dictionary or database 178 having the clustered descriptors. The descriptor weighting module 176 provides weights and/or rankings at 408 to the clustered descriptors so that descriptors that are more relevant are given a greater weight/ranking. The dictionary 178 is updated at 410 by the weighting module 176 to include the weights for the clustered descriptors. At this point, the dictionary 178 is complete and available for deployment in facilitating a trailering function for the tow vehicle 100.

The deployment phase 180, as illustrated in FIG. 5, may be initiated as part of a trailering function, such as a trailer reverse assist or trailer hitch assist operation. An image 144, captured by the rear camera 142a, is received at 502 by the controller 150. A pyramid of scales operation is optionally performed on the received image 144 at 504 by the descriptor scale invariant module 182. Sparse visual features and descriptors are determined from the received image 144 at 506 by the visual feature and descriptor determining module 184. For each feature descriptor determined, the descriptor matching module 186 matches at 508 the feature descriptor with a clustered descriptor entry in the dictionary 178, and the label(s) corresponding to the matched clustered descriptor is assigned to the determined feature descriptor. At 510, the shape determining module 188 determines the convex hull and/or bounding box for the feature descriptors in the received image having assigned thereto a label for a trailer. In addition or in the alternative, the shape determining module 188 determines a convex hull and/or bounding box for the feature descriptors in the received image having assigned thereto a label for a trailer coupler. The convex hull information may then be available at 512 for use in performing a trailer assist function, which may include displaying the captured image 144 and the convex hull in the display 132 of the user interface 130.

These algorithms or modules may be computer programs (also known as programs, software, software applications or code) and include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method for identifying a trailer or trailer coupler in one or more images, the method comprising:
obtaining a database of descriptor clusters, each descriptor cluster having at least one label assigned thereto, each at least one label being a label for a trailer, a trailer coupler, or a background;
receiving, at data processing hardware, image data pertaining to one or more images;
determining, by data processing hardware, features and descriptors in the received image data;
for each determined descriptor, matching, by the data processing hardware, the determined descriptor with a descriptor cluster in the database and assigning the label corresponding to the matched descriptor cluster to the determined descriptor; and
based upon the determined descriptors having the assigned label corresponding to at least one of a trailer or a trailer coupler, determining, by the data processing hardware, a convex hull of a representation of the at least one of the trailer or the trailer coupler in the one or more images.

2. The method of claim 1, further comprising generating the database of descriptor clusters, comprising:
receiving training image data;
generating labels and descriptors for the training image data;
clustering the descriptors; and
generating the database of descriptor clusters from the clustered descriptors.

3. The method of claim 2, further comprising adding weights to each descriptor cluster, wherein generating the database of descriptor clusters is based at least partly upon the weights added to the descriptor clusters.

4. The method of claim 3, wherein adding weights to each descriptor cluster uses a term frequency-inverse document frequency algorithm.

5. The method of claim 2, wherein clustering the descriptors comprises unsupervised learning.

6. The method of claim 2, wherein clustering the descriptors comprises using a k-means clustering algorithm.

7. The method of claim 2, wherein clustering the descriptors comprises using a support vector machine (SVM) learning algorithm.

8. The method of claim 1, further comprising performing a pyramid of scales algorithm on the received image data to produce scale invariant image data, wherein determining features and descriptors comprises determining features and descriptors of the scale invariant image data.

9. The method of claim 1 wherein determining descriptors of the received image data comprises performing one of a SIFT, SURF BRIEF, rBRIEF, HOG or a neural network visual descriptor algorithm.

10. The method of claim 1, wherein determining features of the received image data comprises performing one of a FAST, Harris Corners or a boundary based corner detection algorithm.

11. A system for identifying a trailer or trailer coupler in one or more images, comprising:
a controller comprising data processing hardware and non-transitory memory communicatively coupled to the data processing hardware and having instructions stored therein which, when executed by the data processing hardware, causes the data processing hardware to perform a method comprising:
obtaining a database of descriptor clusters, each descriptor cluster having at least one label assigned thereto, each at least one label being a label for a trailer, a trailer coupler, or a background;
receiving image data pertaining to one or more images;
determining features and descriptors in the received image data;
for each determined descriptor, matching the determined descriptor with a descriptor cluster in the database and assigning the label corresponding to the matched descriptor cluster to the determined descriptor; and
based upon the determined descriptors having the assigned label corresponding to at least one of a trailer or a trailer coupler, determining, by the data processing hardware, a convex hull of a trailer representation of the at least one of the trailer or the trailer coupler in the one or more images.

12. The system of claim 11, wherein the method further comprises generating the database of descriptor clusters, comprising:
receiving training image data;
generating labels and descriptors for the training image data;
clustering the descriptors; and
generating the database of descriptor clusters from the clustered descriptors.

13. The system of claim 12, wherein the method further comprises adding weights to each descriptor cluster, wherein generating the database of descriptor clusters is based at least partly upon the weights added to the descriptor clusters.

14. The system of claim 13, wherein adding weights to each descriptor cluster uses a term frequency-inverse document frequency algorithm.

15. The system of claim 12, wherein clustering the descriptors comprises using one of a k-means clustering algorithm or a support vector machine (SVM) learning algorithm.

16. The system of claim 11, wherein the method further comprises performing a pyramid of scales algorithm on the received image data to produce scale invariant image data, wherein determining features and descriptors comprises determining features and descriptors of the scale invariant image data.

17. The system of claim 11, wherein determining descriptors of the received image data comprises performing one of a SIFT, SURF BRIEF, rBRIEF, HOG a neural network visual descriptor algorithm and determining features of the received image data comprises performing one of a FAST, Harris Corners, or a boundary based corner detection algorithm.

18. A method for identifying a trailer or trailer coupler in one or more images, the method comprising:
receiving training image data;
generating labels and descriptors for the training image data;
clustering the descriptors;
generating a database of descriptor clusters from the clustered descriptors, each descriptor cluster having at least one label assigned thereto, each at least one label being a label for at least a portion of a trailer or a background;
receiving, at data processing hardware, image data pertaining to one or more images; and
based upon the received image data and the database, determining a convex hull of a representation of the at least a portion of the trailer in the one or more images.

19. The method of claim 18, further comprising adding weights to each descriptor cluster, wherein generating the database of descriptor clusters is based at least partly upon the weights added to the descriptor clusters.

20. The method of claim 19, wherein adding weights to each descriptor cluster uses a term frequency-inverse document frequency algorithm.

21. The method of claim 18, further comprising performing a data augmentation operation on the received training image data to produce scale invariant training image data, wherein generating labels and descriptors comprises determining features and descriptors of the scale invariant training image data.
